(19) United States
(12) Patent Application Publication
(10) Pub. No.: US 2002/0133468 A1
(43) Pub. Date: Sep. 19, 2002

(54) Method of electronic commerce transaction verification

(75) Inventor: Andreas Alan Mertens, Vancouver (CA)

Correspondence Address: Hall, Priddy, Myers & Vande Sande, 200-10220 River Road, Potomac, MD, 20854, US

(73) Assignee: I - nvite Communications Inc.

(21) Appl. No.: 09/804,157

(22) Filed: Mar. 13, 2001

(51) Int. Cl. G06F 17/60

(52) U.S. Cl. 705/75

(57) ABSTRACT

A method of electronic commerce transaction verification, wherein a client's selected payment method information is neither provided to nor stored on the server, or elsewhere, of a transaction intermediary.

### FIELD

The present invention is related to method of verifying electronic commerce transactions. More specifically, the present invention is related to a method of handling and providing authorization of payments for electronic commerce transactions.

### BACKGROUND OF THE INVENTION

The Internet continues to grow as a purveyor of goods and services to online customers. Electronic commerce (e-commerce) is becoming the mainstay of numerous merchants and a virtual storefront to complement the physical storefronts of many established merchants.

However, the issue of security during e-commerce transactions provides a deterrent to many consumers and merchants alike. There are currently various methods of carrying out transactions over the Internet with each posing essentially the same risk. In general, transactions across the Internet require intermediaries in order to successfully complete a transaction. A transaction intermediary is any server/agent that lies between the client and the entity providing the payment authorization. For example, a transaction intermediary may be the merchant or a payment agent such as an escrow service.

Referring to FIG. 1, a prior art method of credit card authorization 10 is depicted. At step 22, a client 20 places an order with a merchant 30. The merchant 30 then confirms the order and requests the client's 20 credit card information (step 32). At step 24, the client 20 provides the merchant 30 with the credit card information. In most cases, the merchant 30 stores this credit card information. At step 34, the merchant requests authorization of the client's 20 credit card from the credit card company/credit card agent 40. The credit card company/credit card agent 40 then sends an authorization to the merchant 30 (step 42). The authorization indicates whether the payment request has been accepted or declined. Upon receipt of the authorization, the merchant 30 confirms the authorization and the order with the client 20 (step 36).

In this method, the merchant 30 would be a transaction intermediary. Consequently, this method is prone to security breaches from the merchant's own staff or outside hackers as the merchant 30 stores the client's 20 credit card information, even if only for a short time. This means that the client's 20 credit card information is susceptible to being retrieved and subsequently used without the client's knowledge or consent.

Referring to FIG. 2, a second prior art method of credit card authorization 50 is depicted. At step 62, a client 60 places an order with a merchant 70. The merchant 70 then confirms the order and requests the client 20 contact the payment agent 80 to complete the transaction (step 72). At step 64, the client 60 contacts the payment agent 80 and provides the payment agent 80 with the credit card information. In most cases, the payment agent 80 stores this credit card information, even if only for a short time. At step 82, the payment agent 80 requests authorization of the client's 60 credit card from the credit card company/credit card agent 90. The credit card company/credit card agent 90 then sends an authorization to the payment agent 80 (step 92). The payment agent 80 then sends an authorization to the merchant 70 (step 84) and to the client 60 (step 86). The authorization indicates whether the payment request has been accepted or declined. Upon receipt of the authorization, the merchant 70 confirms the authorization and the order with the client 60 (step 74).

In this method, the payment agent 80 would be a transaction intermediary. Consequently, this method is prone to security breaches from the payment agent's own staff or outside hackers as the payment agent 80 stores the client's 60 credit card information, even if only for a short time. This means that the client's 60 credit card information is susceptible to being retrieved and subsequently used without its knowledge or consent.

Due to the aforementioned security vulnerabilities, consumers are reluctant to engage in e-commerce.

It is, therefore, an object of this invention to provide an improved method of credit card authorization wherein a client's credit card information is not stored on the server of a transaction intermediary.

### SUMMARY OF THE INVENTION

The present invention is generally directed to a method of electronic commerce transaction verification, wherein a client's credit card information is neither provided to nor stored on the server, or elsewhere, of a transaction intermediary.

This method is equally applicable to a variety of payment methods including debit cards. In general, the term “debit card” or even “payment method” may be substituted for the term “credit card” when describing the method.

In its simplest form, a system capable of carrying out electronic commerce using the method of this invention comprises a client, a merchant and a credit card company/authorization agent, all of which are connected via the Internet. However, in practice, there are generally a plurality of clients, merchants, credit card company/authorization agents, and alternative forms of payment requiring authorization for which security in general, and in particular the Internet, is an issue.

A client places an order with a merchant to purchase certain goods. The merchant then sends at least the transaction details, transaction identifier and the merchant's credit card merchant number to the client. Upon receipt of the transaction amount and credit card merchant number, the client sends an authorization request to the credit card company/authorization agent including at least the client's credit card information, the credit card merchant number and the transaction amount. The credit card company/authorization agent then sends authorization information to the client. The authorization may include an authorization number and an indication of whether the transaction was approved or declined. The client forwards the authorization information to the merchant to complete the transaction. The merchant may have the option of verifying the authorization information provided by the client. It is important to note that the authorization number provided by the credit card company/agent to the client is automatically forwarded to the merchant without being visible to the client.

In another aspect of the invention, the client may include their PIN (Personal Identification Number), or some other identifier depending on the chosen method of payment, as part of the credit card information sent to the credit card company/authorization agent. The inclusion of the PIN acts a method of verification of the transaction and authentication of the client initiating the transaction as the credit card holder.

This method provides several advantages over the previous methods. First, the client's credit card information is only stored on the client's computer and not on the merchant's server or some other transaction intermediary. Furthermore, the only other entity that has access to the credit card information is the credit card company/authorization agent who already has the number and with whom the client has presumably already established a trust relationship.

Other objects and advantages of the invention will become clear from the following detailed description of the preferred embodiment, which is presented by way of illustration only and without limiting the scope of the invention to the details thereof.

### BRIEF DESCRIPTION OF THE DRAWINGS

Many objects and advantages of the present invention will be apparent to those of ordinary skill in the art when this specification is read in conjunction with the attached drawings wherein like reference numerals are applied to like elements and wherein:

FIG. 1 is a schematic block diagram of a prior art method of credit card authorization;

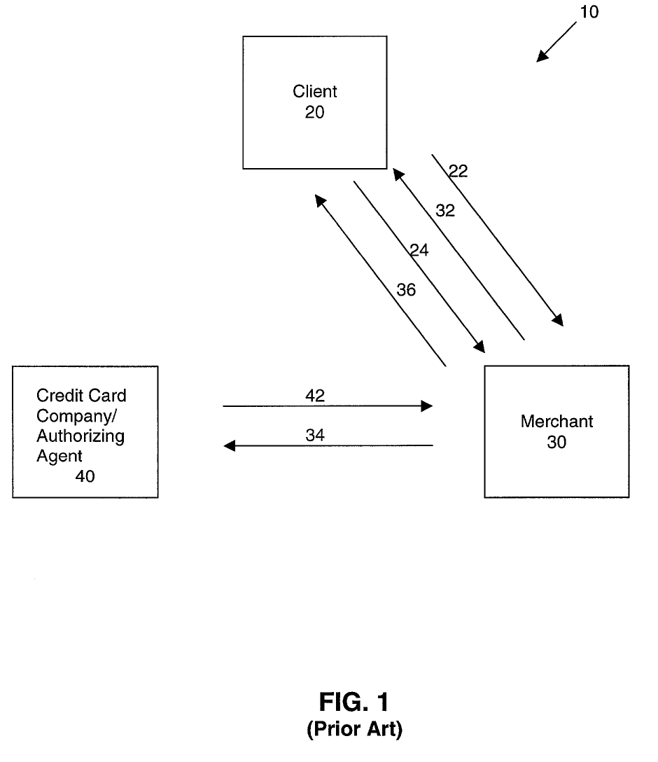

FIG. 2 is a schematic block diagram of a prior art method of credit card authorization;

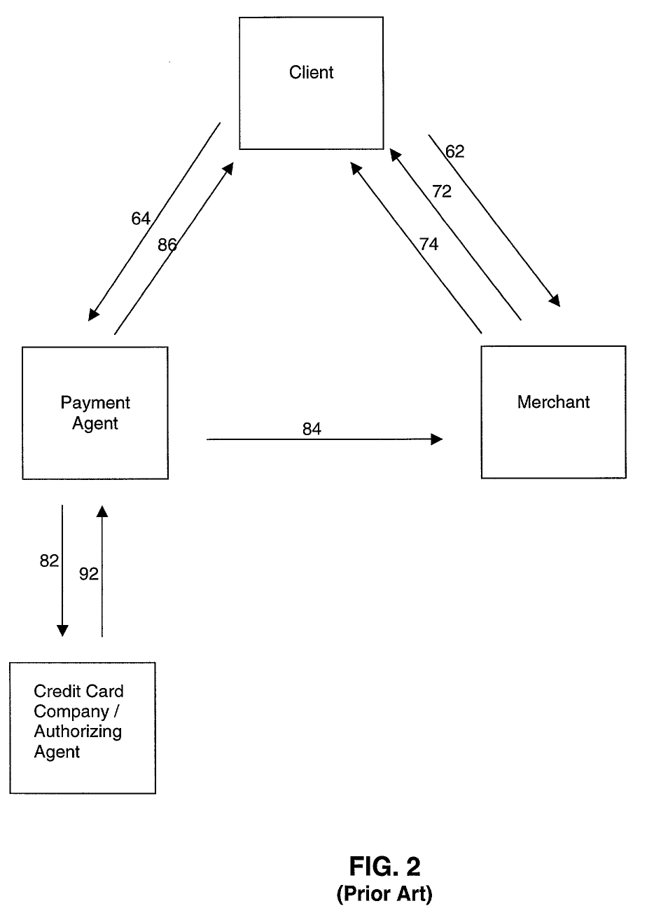

FIG. 3 is a schematic block diagram of a basic embodiment of the invention; and

FIG. 4 is a schematic block diagram of a basic embodiment of the invention.

### DETAILED DESCRIPTION

Conventions

This method is equally applicable to a variety of payment methods including debit cards. In general, the term “payment method” may be substituted for the term “credit card” when describing the method.

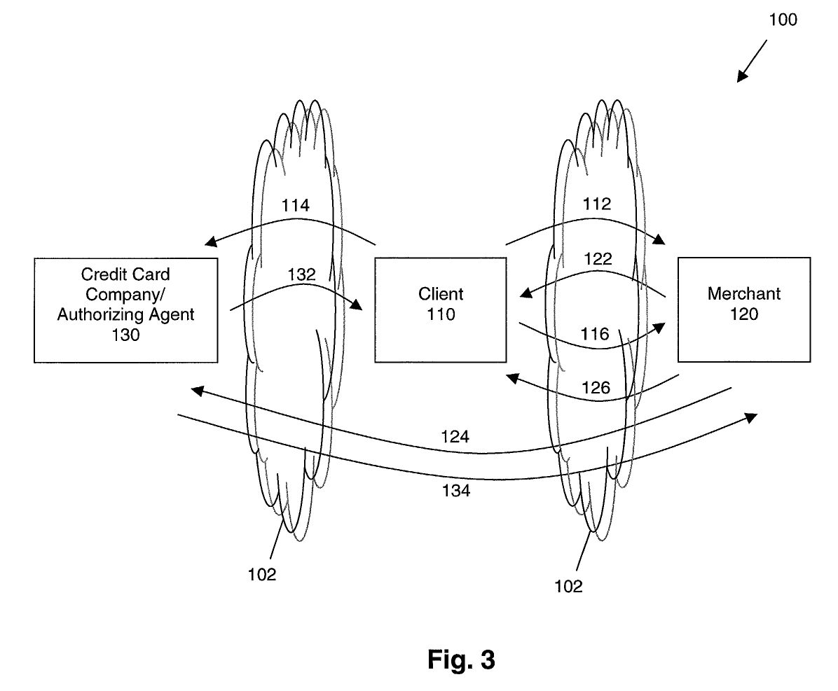

Referring to FIG. 3, a system 100 capable of carrying out electronic commerce transaction verification using the method of this invention comprises a client 110, a merchant 120 and a credit card company/agent 130, all of which are connected via the Internet 102.

In general, the method commences when the client 110 sends a purchase request (step 112) to the merchant 120. At step 122, the merchant 120 responds to the client 110 with transaction information including a purchase identifier, the credit card merchant number of the merchant 120 and a credit card company/agent 130 identifier. Upon receipt of the transaction information, the client 110 sends an authorization request to the credit card company/authorizing agent 130 (step 114). The authorization request generally includes the credit card merchant number of the merchant 120, the transaction amount, transaction identifier and the credit card information of the client 110. The credit card company/authorizing agent 130 processes the authorization request and sends authorization information to the client (step 132). The authorization information will generally include an authorization number and an indication of whether the transaction amount was accepted or declined.

Once the client 110 receives the transaction information, at step 116 it is automatically forwarded to the merchant 120. If the credit card company/authorizing agent 130 has accepted the transaction then the merchant 120 sends a purchase request confirmation to the client 110 (step 126).

As a further security measure for the merchant 120 and the client 110, prior to step 126, at step 124 the merchant may send a query to the credit card company/authorizing agent 130 verifying the authorization number provided by the client 110. The credit card company/authorizing agent 130 will then respond with verification of the authorization number (step 134).

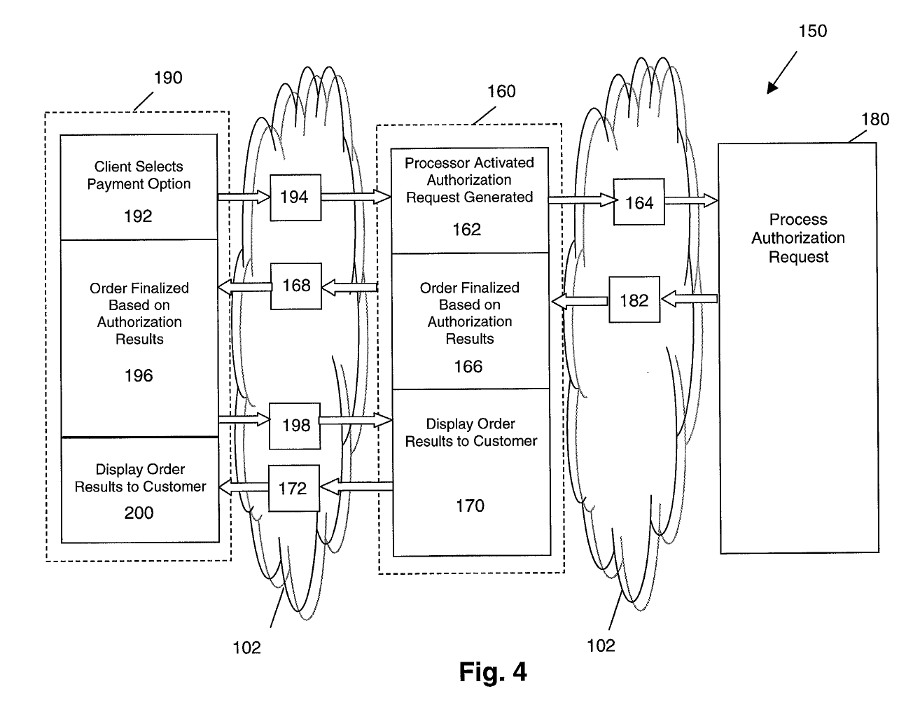

Referring to FIG. 4, an alternate embodiment of the invention is depicted. A system 150 capable of carrying out electronic commerce transaction verification using the method of this invention comprises a client 160, a merchant 190 and a credit card company/authorizing agent 180, all of which are connected via the Internet 102.

The client 160 visits the website of a merchant 190. The client selects the good(s) they wish to purchase. After confirming his/her selection(s), the client 160 selects the credit card payment option on the merchant website (step 192). Next, at step 194, the merchant 190 sends transaction information to the client 160. The transaction information may include a purchase identifier, the credit card merchant number for the merchant 190, and a credit card company/authorizing agent 180 identifier.

At step 162, the receipt of the transaction information by the client 160, initiates the credit card payment process. The credit card payment process takes the credit card information of the client 160 and creates a credit card authorization request. The credit card information of the client 160 may be entered by the client 160 or may be stored elsewhere on the client's computer and retrieved during the creation of the credit card authorization request.

At step 164, the client 160 sends the credit card authorization request to the credit card company/authorizing agent 180. Upon processing the credit card authorization request, the credit card company/authorizing agent 180 sends an authorization response to the client 160 (step 182). At step 166, the client 160 receives the authorization response from the credit card company/authorizing agent 180. The authorization response will generally include an authorization number and an indication of whether the transaction was approved or declined.

The authorization response is then sent from the client 160 to the merchant 190 (step 168). At step 196, the merchant 190 receives the authorization response, and if the transaction was approved then the order placed by the client 160 is finalized and a link to an order confirmation webpage is sent to the client 160 (step 198). As described previously, the merchant 190 may send an authorization confirmation request to the credit card company/authorizing agent 180 to confirm the transaction was approved.

At step 170, the link causes the client 160 to review the order confirmation. At step 172, the client 160 requests the webpage to display the order confirmation and, at step 200, the page is displayed thereby completing the transaction between the merchant 190 and the client 160. The merchant 190 then ships the purchased items to the client 160.

As discussed previously, at step 162, the credit card authorization request may further include the credit card PIN to ensure the validity of the transaction.

The method discussed above provides several advantages over traditional method of carrying out electronic commerce. Utilizing the method of this invention, a client's credit card information is only stored on the client's computer. The only other entity that receives the client's credit card information is the credit card company/authorization agent, and it is presumed that the client has entered into a trust relationship with the credit card company/authorization agent, as it is the issuer of the credit card.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A method for providing secure transaction verification within a transactional system, wherein said transactional system includes at least a client, a merchant and an authorizer, said method comprising the steps of:
(a) transmitting a transaction request from said client to said merchant;
(b) transmitting transaction information from said merchant to said client;
(c) generating an authorization request;
(d) transmitting said authorization request from said client to said authorizer;
(e) processing said authorization request;
(f) transmitting an authorization response from said authorizer to said client; and
(g) transmitting said authorization response from said client to said merchant.

2. The method according to claim 1, wherein said transaction request includes a method of payment.

3. The method according to claim 1, wherein said transaction information includes a transaction amount, a transaction identifier and a merchant's payment number.

4. The method according to claim 2, wherein said payment method is a credit card account.

5. The method according to claim 2, wherein said payment method is a debit card account.

6. The method according to claim 3, wherein said authorization request includes at least said transaction amount, said merchant's payment number and said client's payment information.

7. The method according to claim 6, wherein said client's payment information includes a credit card account number.

8. The method according to claim 6, wherein said client's payment information includes a debit card account number.

9. The method according to claim 6, wherein said authorization request further includes a client identifier.

10. The method according to claim 1, further including the steps of:
(h) transmitting an authorization verification request from said merchant to said authorizer; and
(i) transmitting an authorization verification from said authorizer to said merchant.

11. The method according to claim 9, wherein said client identifier is a personal identification number.

12. The method according to claim 9, wherein said client identifier is personal identification code.

13. The method according to claim 1, wherein at step (g), said transmittal of said authorization response is not visible to said client.

14. The method according to claim 1, wherein said authorization response includes either an authorization approval and an authorization number or an authorization declination.
